(19) United States
(12) Patent Application Publication
(10) Pub. No.: US 2025/0151064 A1
(43) Pub. Date: May 8, 2025

(54) TECHNIQUES FOR DYNAMIC UPLINK TRANSMISSION SWITCHING

(71) Applicant: QUALCOMM Incorporated, San Diego, CA (US)

(72) Inventors: Yiqing CAO, Beijing (CN); Peter GAAL, San Diego, CA (US); Masato KITAZOE, Hachiouji-shi (JP); Bin HAN, Beijing (CN); Yi HUANG, San Diego, CA (US); Kazuki TAKEDA, Minato-ku, Tokyo (JP); Wanshi CHEN, San Diego, CA (US)

(21) Appl. No.: 18/838,955

(22) PCT Filed: Apr. 8, 2022
(86) PCT No.: PCT/CN2022/085705

§ 371 Date: Aug. 15, 2024

(51) Int. Cl. H04W 72/21; H04W 72/0453

(52) U.S. Cl. CPC H04W 72/21; H04W 72/0453

(57) ABSTRACT

Various aspects of the present disclosure generally relate to wireless communication. In some aspects, a user equipment (UE) may transmit an indication of a set of frequency bands supported for uplink transmission switching between frequency bands, the frequency bands including one or more bandwidth parts. The UE may transmit an indication of a subset of the set of frequency bands, the subset supported for dynamic uplink transmission switching between the frequency bands. The UE may transmit one or more uplink communications via one or more frequency bands of the subset of the set of frequency bands. Numerous other aspects are described.

### FIELD OF THE DISCLOSURE

Aspects of the present disclosure generally relate to wireless communication and to techniques and apparatuses for dynamic uplink transmission switching.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting an indication of a set of frequency bands supported for uplink transmission switching between frequency bands, the frequency bands including one or more bandwidth parts. The method may include transmitting an indication of a subset of the set of frequency bands, the subset supported for dynamic uplink transmission switching between the frequency bands. The method may include transmitting one or more uplink communications via one or more frequency bands of the subset of the set of frequency bands.

Some aspects described herein relate to a method of wireless communication performed by a base station. The method may include receiving an indication of a set of frequency bands supported for uplink transmission switching between frequency bands, the frequency bands including one or more bandwidth parts. The method may include receiving an indication of a subset of the set of frequency bands, the subset supported for dynamic uplink transmission switching between the frequency bands. The method may include receiving one or more uplink communications via one or more frequency bands of the subset of the set of frequency bands.

Some aspects described herein relate to a UE for wireless communication. The user equipment may include a memory and one or more processors coupled to the memory. The one or more processors may be configured to transmit an indication of a set of frequency bands supported for uplink transmission switching between frequency bands, the frequency bands including one or more bandwidth parts. The one or more processors may be configured to transmit an indication of a subset of the set of frequency bands, the subset supported for dynamic uplink transmission switching between the frequency bands. The one or more processors may be configured to transmit one or more uplink communications via one or more frequency bands of the subset of the set of frequency bands.

Some aspects described herein relate to a base station for wireless communication. The base station may include a memory and one or more processors coupled to the memory. The one or more processors may be configured to receive an indication of a set of frequency bands supported for uplink transmission switching between frequency bands, the frequency bands including one or more frequency bandwidth parts. The one or more processors may be configured to receive an indication of a subset of the set of frequency bands, the subset supported for dynamic uplink transmission switching between the frequency bands. The one or more processors may be configured to receive one or more uplink communications via one or more frequency bands of the subset of the set of frequency bands.

Some aspects described herein relate to a non-transitory computer-readable medium that stores a set of instructions for wireless communication by a UE. The set of instructions, when executed by one or more processors of the UE, may cause the UE to transmit an indication of a set of frequency bands supported for uplink transmission switching between frequency bands, the frequency bands including one or more bandwidth parts. The set of instructions, when executed by one or more processors of the UE, may cause the UE to transmit an indication of a subset of the set of frequency bands, the subset supported for dynamic uplink transmission switching between the frequency bands. The set of instructions, when executed by one or more processors of the UE, may cause the UE to transmit one or more uplink communications via one or more frequency bands of the subset of the set of frequency bands.

Some aspects described herein relate to a non-transitory computer-readable medium that stores a set of instructions for wireless communication by a base station. The set of instructions, when executed by one or more processors of the base station, may cause the base station to receive an indication of a set of frequency bands supported for uplink transmission switching between frequency bands, the frequency bands including one or more bandwidth parts. The set of instructions, when executed by one or more processors of the base station, may cause the base station to receive an indication of a subset of the set of frequency bands, the subset supported for dynamic uplink transmission switching between the frequency bands. The set of instructions, when executed by one or more processors of the base station, may cause the base station to receive one or more uplink communications via one or more frequency bands of the subset of the set of frequency bands.

Some aspects described herein relate to an apparatus for wireless communication. The apparatus may include means for transmitting an indication of a set of frequency bands supported for uplink transmission switching between frequency bands, the frequency bands including one or more bandwidth parts. The apparatus may include means for transmitting an indication of a subset of the set of frequency bands, the subset supported for dynamic uplink transmission switching between the frequency bands. The apparatus may include means for transmitting one or more uplink communications via one or more frequency bands of the subset of the set of frequency bands.

Some aspects described herein relate to an apparatus for wireless communication. The apparatus may include means for receiving an indication of a set of frequency bands supported for uplink transmission switching between frequency bands, the frequency bands including one or more bandwidth parts. The apparatus may include means for receiving an indication of a subset of the set of frequency bands, the subset supported for dynamic uplink transmission switching between the frequency bands. The apparatus may include means for receiving one or more uplink communications via one or more frequency bands of the subset of the set of frequency bands.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a configuration of multiple frequency bands having one or more bandwidth parts, in accordance with the present disclosure.

FIGS. 5-7 are diagrams illustrating examples associated with dynamic uplink transmission switching, in accordance with the present disclosure.

FIGS. 8 and 9 are diagrams illustrating example processes associated with dynamic uplink transmission switching, in accordance with the present disclosure.

FIGS. 10 and 11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

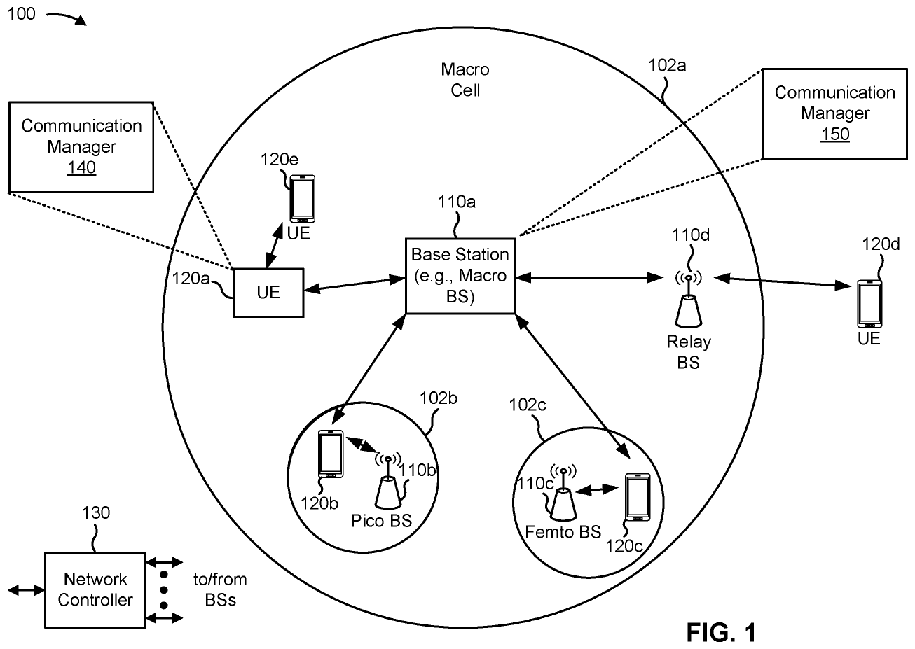

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit an indication of a set of frequency bands supported for uplink transmission switching between frequency bands, the frequency bands including one or more bandwidth parts; transmit an indication of a subset of the set of frequency bands, the subset supported for dynamic uplink transmission switching between the frequency bands; and transmit one or more uplink communications via one or more frequency bands of the subset of the set of frequency bands. Additionally, or alternatively, the communication manager 140 may perform one or more other operations described herein.

In some aspects, the base station 110 may include a communication manager 150. As described in more detail elsewhere herein, the communication manager 150 may receive an indication of a set of frequency bands supported for uplink transmission switching between frequency bands, the frequency bands including one or more bandwidth parts; receive an indication of a subset of the set of frequency bands, the subset supported for dynamic uplink transmission switching between the frequency bands; and receive one or more uplink communications via one or more frequency bands of the subset of the set of frequency bands. Additionally, or alternatively, the communication manager 150 may perform one or more other operations described herein.

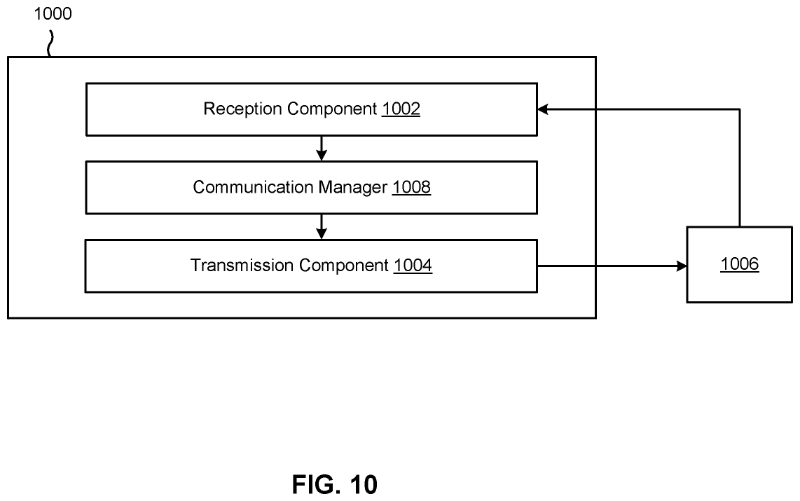

In some aspects, the term “base station” (e.g., the base station 110) or “network node” or “network entity” may refer to an aggregated base station, a disaggregated base station (e.g., described in connection with FIG. 10), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

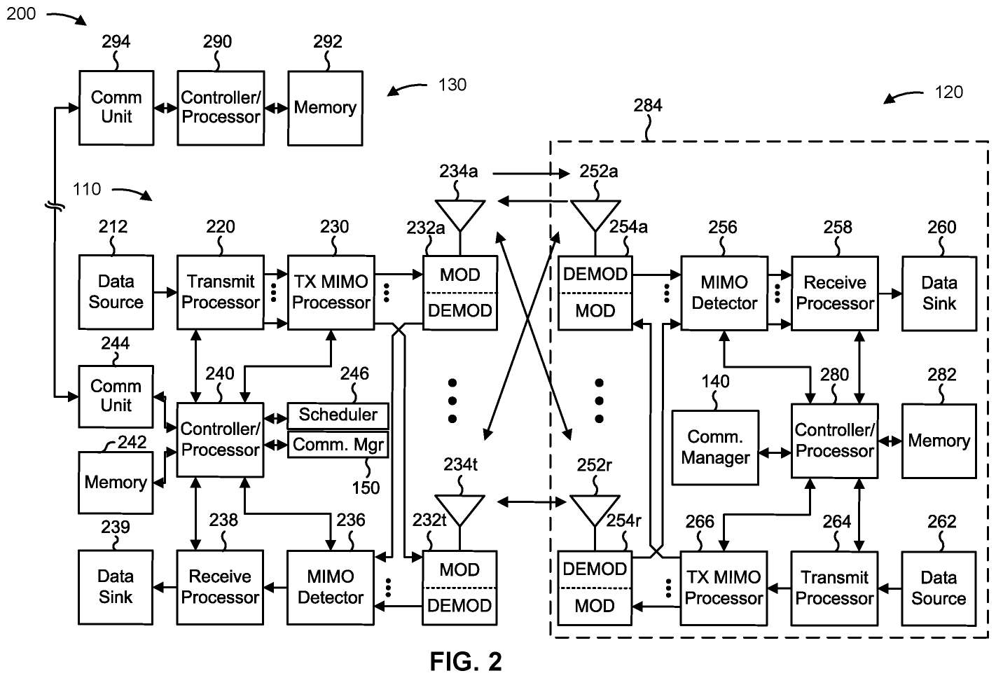

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

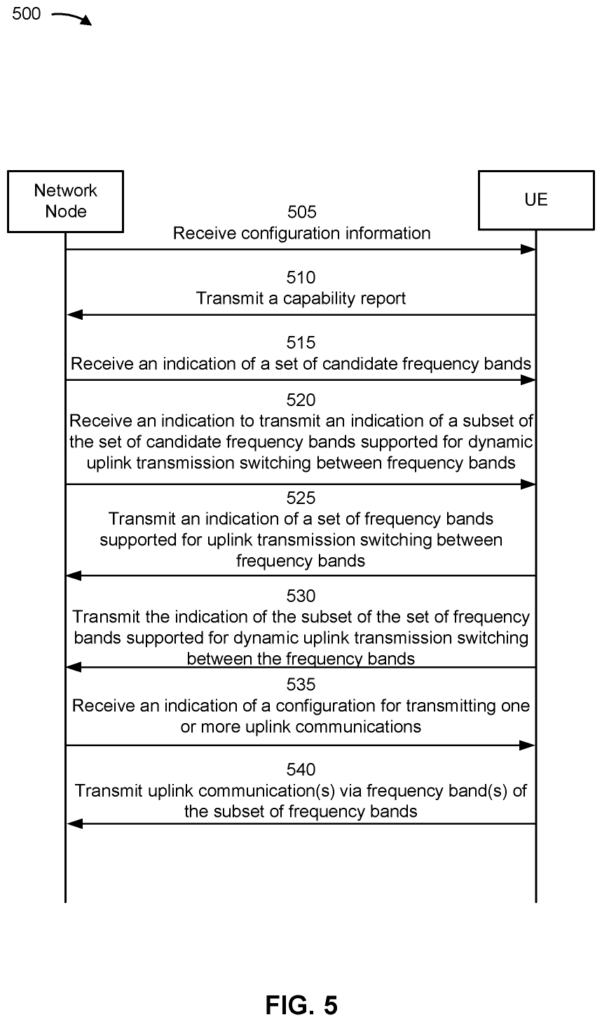

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

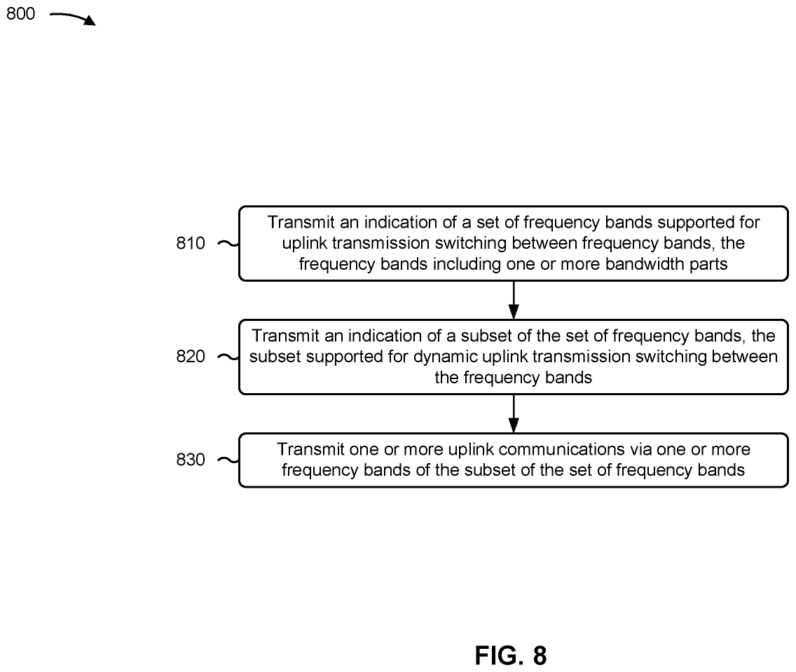

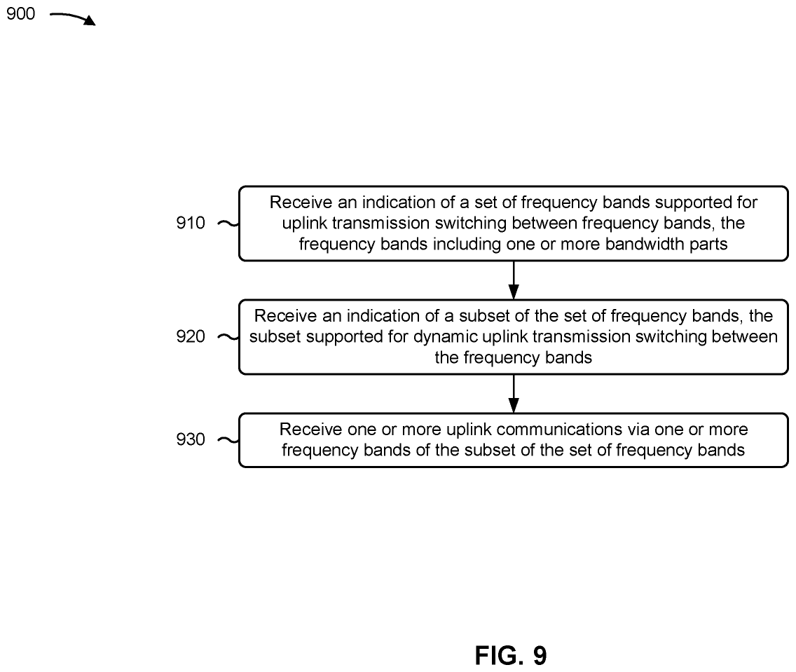

The controller/processor 240 of the base station 110, the controller/processor 280 of the UE 120, and/or any other component(s) of FIG. 2 may perform one or more techniques associated with dynamic uplink transmission switching, as described in more detail elsewhere herein. In some aspects, the network node described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for transmitting an indication of a set of frequency bands supported for uplink transmission switching between frequency bands, the frequency bands including one or more bandwidth parts; means for transmitting an indication of a subset of the set of frequency bands, the subset supported for dynamic uplink transmission switching between the frequency bands; and/or means for transmitting one or more uplink communications via one or more frequency bands of the subset of the set of frequency bands. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for receiving an indication of a set of frequency bands supported for uplink transmission switching between frequency bands, the frequency bands including one or more bandwidth parts; means for receiving an indication of a subset of the set of frequency bands, the subset supported for dynamic uplink transmission switching between the frequency bands; and/or means for receiving one or more uplink communications via one or more frequency bands of the subset of the set of frequency bands. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

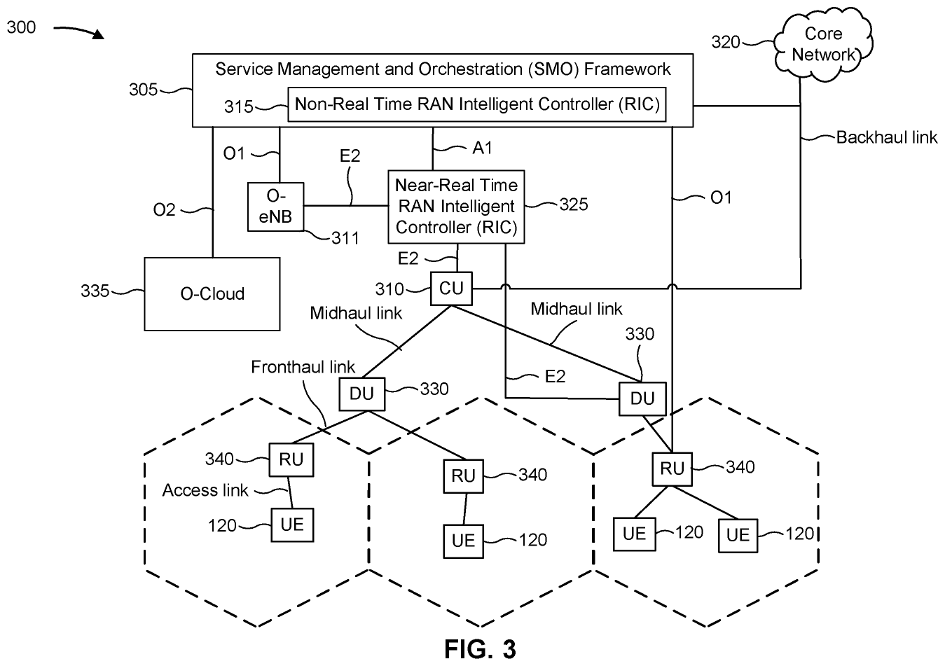

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 335) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

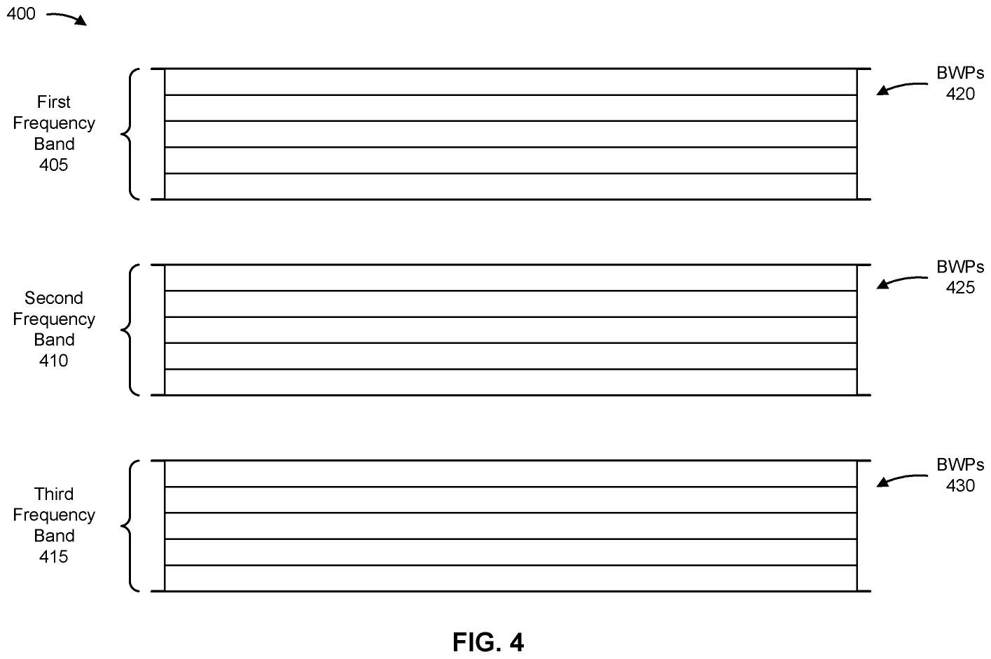

FIG. 4 is a diagram illustrating an example 400 of a configuration of multiple frequency bands having one or more bandwidth parts (BWPs), in accordance with the present disclosure. The multiple frequency bands may be used for communications between nodes of a wireless network. For example, a UE and a base station may communication via one or more of the multiple frequency bands.

The multiple bands may include, for example, a first frequency band 405, a second frequency band 410, and a third frequency band 415. The first frequency band 405 may include one or more BWPs 420 (shown as having 5 BWPs, for example), the second frequency band 410 may include one or more BWPs 425, and the third frequency band 415 may include one or more BWPs 430.

The frequency bands may be non-overlapping frequency bands. The frequency bands may be within a same or different frequency ranges (e.g., FR1, FR2, FR3, etc.). The frequency bands may be adjacent frequency bands (e.g., an upper end of the second frequency band 410 is approximately at a lower end of the first frequency band 405, among other examples) or may be spaced from each other (e.g., on different frequency ranges).

Although the first frequency band 405, the second frequency band 410, and the third frequency band 415 are each shown having 5 BWPs, each of the frequency bands may have more than or fewer than 5 BWPs. For example, the first frequency band 405 may have more BWPs than the third frequency band 415.

The BWPs 420, 425, 430 may be further divided into frequency resources (e.g., component carriers) that may be allocated for communications between the nodes of the wireless network. For example, the BWPs 420, 425, 430 may include frequency resources that are used for one or more channels of communication, such as a physical downlink control channel (PDCCH), a physical downlink shared channel (PDSCH), a physical uplink control channel (PUCCH), a physical uplink shared channel (PUSCH), a physical sidelink shared channel (PSSCH), and/or a physical sidelink control channel (PSCCH), among other examples.

As indicated above, FIG. 4 is provided as an example. Other examples may differ from what is described with regard to FIG. 4.

In some networks, a UE may be capable of communicating in multiple frequency bands. For example, the UE may be configured to communicate in up to 4 frequency bands. A network node may indicate to the UE that the UE is to communicate with the network node via one or more of the multiple frequency bands (e.g., up to 4 frequency bands). Additionally, or alternatively, the UE may be capable of communicating via multiple component carriers. For example, the UE may be capable of communicating via multiple component carriers of a same frequency band or via multiple component carries of different frequency bands.

In some networks, the network node may indicate that the UE is to dynamically switch between component carriers from a set of component carriers that the UE supports. For example, the network node may indicate with a dynamic control message (e.g., a MAC layer communication or downlink control information (DCI), among other examples) that the UE is to switch between component carriers. The dynamic control message may follow a semi-static control message (e.g., an RRC message) that indicates component carriers from which the dynamic control messages may indicate to the UE.

In some networks, the UE is configured to communication in up to 4 frequency bands and is configured to dynamically switch between component carriers. However, dynamic switching among several frequency bands (e.g., 4 frequency bands) may be complicated (e.g., for an option 2 carrier aggregation UE), and may consume computing, power, network, and/or communication resources to implement. For example, configuration signaling and/or dynamically signaling associated with dynamic switching may consume an amount of overhead (e.g., non-data carrying network resources) that is based at least in part on a number of frequency bands supported for the dynamic switching.

In some aspects described herein, a UE may transmit an indication of frequency bands that the UE supports for dynamic switching (e.g., dynamic uplink transmission switching). For example, the UE may indicate a subset of a set of frequency bands (associated with uplink transmission switching) for which the UE supports dynamic uplink transmission switching. The UE may indicate, using a first information element, a number of frequency bands that the UE supports for uplink transmission switching and may indicate, using a second information element, a number of frequency bands that the UE supports for dynamic uplink transmission switching.

In some aspects, the UE may indicate the set of frequency bands that the UE supports for uplink transmission switching (e.g., frequency band A, frequency band B, frequency band C, and frequency band D, among other examples). The UE may also indicate a number of the frequency bands that the UE supports for dynamic uplink transmission switching. For example, the UE may indicate a number that is less than or equal to a number of frequency bands that are indicated as supported for uplink transmission switching.

In some aspects, the UE may transmit an indication of supported frequency bands for uplink transmission switching using an information element, such as an information element of an RRC message. For example, the UE may transmit the indication of supported frequency bands for uplink transmission switching within supportedBandCombinationList-UplinkTxSwitch-R18, for example, along with other information elements. The RRC message may define NR inter-band uplink carrier aggregation and/or supplemental uplink frequency band combinations where the UE supports dynamic uplink transmission switching. In some aspects, the UE may include this information element if (e.g., only if) requested by the network node. All fallback band combinations resulting from a reported band combination, which include at least one frequency band pair supporting dynamic uplink transmission switching as indicated in ULTxSwitchingBandPair, may be supported by the UE. In some aspects, the UE may report up to a threshold number of frequency bands (e.g., 4 frequency bands).

In some aspects, the UE may indicate 3 frequency bands supported for dynamic uplink transmission switching using an information element (e.g., ULTxSwitchingBandPair-3bands). The information element may indicate UE support for dynamic uplink transmission switching in cases of inter-band carrier aggregation and/or supplemental uplink. Capability signaling may include bandIndexUL1, bandIndexUL2, and bandIndexUL3 to indicate a band pair (e.g., band set) on which the UE supports dynamic UL Tx switching. For example, bandindexUL1/bandindexUL2/bandindexUL3 refers to a kth band entry in the band combination.

In some aspects, the UE may indicate 4 frequency bands supported for dynamic uplink transmission switching using an information element (e.g., ULTxSwitchingBandPair-4bands). The information element may indicate UE support for dynamic uplink transmission switching in cases of inter-band carrier aggregation and/or supplemental uplink. Capability signaling may include bandIndexUL1, bandIndexUL2, and bandIndexUL3 to indicate a band pair (e.g., band set) on which the UE supports dynamic UL Tx switching. For example, bandIndexUL1, bandIndexUL2, bandIndexUL3 and bandIndexUL4 indicate the band pair on which UE supports dynamic UL Tx switching. bandindexUL1/bandindexUL2/bandindexUL3/bandindexUL4 refers to a kth band entry in the band combination.

In some aspects, another information element (e.g., uplinkTxSwitchingPeriod) indicates a length of an uplink transmission switching period per pair of uplink bands per band combination when dynamic uplink transmission switching is configured (e.g., as specified in a communication standard). In some aspects, n35us represents 35 microseconds (μs), n140us represents 140 μs, and so on, as specified in the communication standard. In some aspects, another information element (e.g., uplinkTxSwitchingPeriod2Tx-2Tx) indicates a length of uplink transmission switching period per pair of uplink bands per band combination when dynamic uplink transmission switching is configured, and the UE is capable of 2-layer uplink MIMO on all the frequency bands.

In some aspects, the UE may transmission an indication of supported frequency bands for dynamic uplink transmission switching using an information element, such as an information element of an RRC message. For example, the UE may transmit the indication of supported frequency bands for dynamic uplink transmission switching within SupportedDynamicSwitchingBands, for example, along with other information elements. The RRC message may define a supported number of frequency bands for dynamic switching for inter-band carrier aggregation and/or supplemental uplink. In some aspects, a candidate value for the information element may satisfy a threshold (e.g., 2 and or a threshold associated with indicated band numbers in supportedBandCombinationList-UplinkTxSwitch-R18). In some aspects, the UE may include this field if (e.g., only if) requested by the network.

In some aspects, the network node may transmit an indication of a number of transmission chains and/or component carriers for the UE to use on each frequency band. For example, the network node may indicate two frequency bands on which the UE is to use a single transmission chain and/or component carrier. Alternatively, the network node may indicate one frequency band on which the UE is to use two transmission chains and/or component carriers.

In some aspects, the network node may configure the UE for dynamic uplink transmission switching based at least in part on one or more control signals. For example, the network node may use RRC signaling to configure the band pair corresponding to a UE reported capability for dynamic uplink transmission switching. During the RRC configuration, the UE may switch among configured bands until a new configuration is signaled and/or implemented.

In some aspects, the network node may use one or more MAC control elements (CEs) to activate and/or deactivate uplink component carriers based at least in part on the UE reported capability for dynamic uplink transmission switching (e.g., a reported number of dynamic switching bands). An activation message may include an uplink carrier identification, an activation time, and/or a duration for activation.

In some aspects, the network node may use a combination of RRC signaling and a dynamic indication (e.g., DCI or MAC CE). For example, the network node may use the RRC signaling to configure a band combination and may use the dynamic indication to activate the configuration.

Based at least in part on the UE transmitting an indication of supported frequency bands for dynamic uplink transmission switching (e.g., as a subset of frequency bands for uplink transmission switching), the UE may conserve computing, power, network, and/or communication resources that may have otherwise been used to attempt to use dynamic uplink transmission switching over with all of the frequency bands supported for uplink transmission switching. Additionally, or alternatively, the UE may conserve computing, power, network, and/or communication resources that may have otherwise been used to communication with unnecessary overhead and/or to detect and correct errors associated with attempting to use dynamic uplink transmission switching over with all of the frequency bands supported for uplink transmission switching (e.g., when an associated complexity exceeds a capability of the UE).

FIG. 5 is a diagram of an example 500 associated with dynamic uplink transmission switching, in accordance with the present disclosure. As shown in FIG. 5, a network node (e.g., base station 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 5.

As shown by reference number 505, the network node may transmit, and the UE may receive, configuration information. In some aspects, the UE may receive the configuration information via one or more of RRC signaling, one or more MAC CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit a capability report associated with uplink transmission switching and/or dynamic uplink transmission switching. In some aspects, the configuration information may configure one or more capability information elements for the capability report. In some aspects, the configuration information may indicate a configuration for receiving an indication of frequency bands to use for dynamic uplink transmission switching.

The UE may configure itself based at least in part on the configuration information. In some aspects, the UE may be configured to perform one or more operations described herein based at least in part on the configuration information.

As shown by reference number 510, the UE may transmit, and the network node may receive, a capabilities report. In some aspects, the capabilities report may indicate UE support for dynamic uplink transmission switching. In some aspects, the capabilities report may include an indication of support for transmitting an indication of the subset of the set of frequency bands. In some networks, not all UEs may support transmitting an indication of the subset of the set of frequency bands and may therefore be set to a default number of frequency bands (e.g., 1 or 2) for dynamic uplink transmission switching.

As shown by reference number 515, the UE may receive, and the network node may transmit, an indication of a set of candidate frequency bands that the network and UE may use to communicate. In some aspects, the UE is configured to determine which of the set of candidate frequency bands the UE supports for uplink transmission switching and/or for dynamic uplink transmission switching.

As shown by reference number 520, the UE may receive, and the network node may transmit, an indication for the UE to transmit an indication of a subset of the set of candidate frequency bands supported for dynamic uplink transmission switching between frequency bands. For example, the network node may indicate for the UE to transmit the indication of the subset based at least in part on the network node and/or an associated network supporting dynamic uplink transmission switching and a UE-indication-based number of frequency bands to use for dynamic uplink transmission switching.

As shown by reference number 525, the UE may transmit, and the network node may receive, an indication of a set of frequency bands supported for uplink transmission switching between frequency bands. For example, the UE may transmit identifications of frequency bands on which the UE supports communication with the base station. The frequency bands may include one or more bandwidth parts. In some aspects, one or more of the frequency bands support (e.g., include resources for) multiple bandwidth parts and/or multiple candidate component carriers.

In some aspects, the set of frequency bands supported for uplink transmission switching between frequency bands includes more than two frequency bands. For example, the set may include 3 frequency bands or 4 frequency bands. In some aspects, the indication of the set of frequency bands may indicate all frequency bands supported by the UE (e.g., based at least in part on hardware and/or a configuration of the UE). The UE may indicate the frequency bands using identifiers from a communication standard. For example, the UE may indicate that the UE supports n1, n3, n41, and/or n79 frequency bands as defined in a communication standard. In some aspects, the UE may indicate an index for referencing the supported frequency bands (e.g., n1=A, n3=B, n51=C, and/or n79=D).

In some aspects, the indication of the set may include an indication of one or more switching periods (e.g., an amount of time needed to switch between frequency bands for transmission) associated with dynamic uplink transmission switching between frequency bands of the set of frequency bands. In some aspects, the indication may include indications of different switching periods for switching between different pairs of the frequency bands. For example, the indication may include a first switching period associated with switching between a first frequency band and a second frequency band, a second switching period associated with switching between the first frequency band and a third frequency band, and/or a third switching period associated with switching between the second frequency band and the third frequency band, etc. In some aspects, the switching period may be symmetric when switching in both directions between two frequency bands, while in other aspects, the switching period may be different when switching between two frequency bands depending on a direction (e.g., switching from A to B may be different than switching from B to A). Additionally, or alternatively, the switching period may be based at least in part on a number of transmission chains used in a current frequency band and/or a number of transmission chains to be used in a subsequent frequency band (e.g., switching from 2 transmission chains on A to 2 transmission chains on B may be different from switching from 1 transmission chain on A to 1 or 2 transmission chains on B).

As shown by reference number 530, the UE may transmit, and the network node may receive, the indication of the subset of the set of frequency bands supported for dynamic uplink transmission switching between the frequency bands. In some aspects, the UE may transmit the indication of the subset based at least in part on receiving the indication to transmit the indication of the subset as described in connection with reference number 520. Alternatively, the UE may transmit the indication of the subset independently from (e.g., in the absence of) receiving the indication to transmit the indication of the subset as described in connection with reference number 520.

In some aspects, the indication of the subset may indicate a number of frequency bands that may be included in the subset (e.g., and not identify the frequency bands). The number of frequency bands within the subset may satisfy a threshold that is based at least in part on a configuration of the UE and/or a number of frequency bands indicated in the set of frequency bands supported for uplink transmission switching, among other examples. For example, the number of frequency bands supported for dynamic uplink transmission switching is less than or equal to a number of frequency bands within the set of frequency bands for uplink transmission switching.

In some aspects, the UE may support the subset of the set of frequency bands for dynamic uplink transmission switching for carrier aggregation and/or supplemental uplink. For example, the UE may indicate support for the subset for carrier aggregation and/or for supplemental uplink configurations.

As shown by reference number 535, the UE may receive, and the network node may transmit, an indication of a configuration for transmitting one or more uplink communications. In some aspects, the UE may transmit (e.g., via RRC or MAC CE signaling) the indication of the configuration based at least in part on the UE transmitting the indication of the subset of the set of frequency bands. The configuration may indicate the frequency bands for the one or more uplink communications. For example, the configuration may indicate to use a first frequency band and a second frequency band for a first set of uplink communications. In some aspects, the configuration may indicate to use the second frequency band and a third frequency band for a second set of uplink communications (e.g., a subsequent set of uplink communications). In some aspects, the configuration may include indications for one set of uplink communications or for multiple sets of configurations. In some aspects, the configuration may prevent violation of one or more configurations (e.g., the indicated subset) across a configuration boundary.

In some aspects, the UE may receive the indication of the configuration via RRC signaling, MAC signaling, and/or DCI. In some aspects, the configuration may include an indication (e.g., RRC or MAC CE) of multiple candidate frequency bands for dynamic uplink transmission switching and/or an indication of a single frequency band supporting multiple carriers for dynamic uplink transmission switching. In some aspects, the network node may subsequently transmit an indication of a dynamic switch via dynamic signaling (e.g., MAC CE or DCI, among other examples). For example, the UE may receive the MAC signaling or the DCI after a configuration of the subset of the set of frequency bands via the RRC signaling, with the MAC signaling or the DCI activating or deactivating the subset of the set of frequency bands and/or one or more uplink carriers associated with the subset of the set of frequency bands.

In some aspects, the configuration may indicate a set of frequency bands configured for dynamic uplink transmission switching and one or more frequency bands that are not configured for dynamic uplink transmission switching. For example, the configuration may indicate that dynamic uplink transmission switching is configured between frequency bands A and B and that dynamic uplink transmission switching is not configured for frequency band C. The indication may include an explicit component and/or an implicit component. For example, the indication may explicitly indicate that that dynamic uplink transmission switching is configuration for frequency bands A and B, which may implicitly indicate that dynamic uplink transmission switching is not configured for frequency band C and/or any other frequency bands. Alternatively, the indication may explicitly indicate that dynamic uplink transmission switching is not configured for frequency band C, which may implicitly indicate that dynamic uplink transmission switching is configured for frequency bands A and B (e.g., based at least in part on the set of frequency bands identifying frequency bands A, B, and C as supported frequency bands).

In some aspects, based at least in part on receiving a resource allocation for an uplink communication via the frequency band that is not configured for dynamic uplink transmission switching (e.g., frequency band C) the UE may not expect a resource allocation for an uplink communication via the set of frequency bands configured for dynamic uplink transmission switching. For example, based at least in part on receiving the resource allocation for an uplink communication via the frequency band that is not configured for dynamic uplink transmission switching, the UE may disable the frequency bands configured for dynamic uplink transmission switching, deactivate simultaneous transmission via multiple frequency bands, and/or consider a resource allocation for an uplink communication via the frequency bands configured for dynamic uplink transmission switching as an error and may ignore the resource allocation, among other examples. As shown by reference number 540, the UE may transmit, and the base station may receive, the one or more uplink communications via one or more frequency bands of the subset of frequency bands. For example, the UE may transmit the one or more communications via the one or more frequency bands that are within a set of one or more frequency bands configured by the base station (e.g., in connection with reference number 535). In some aspects, the number of the one or more frequency bands of the set of the one or more frequency bands is based at least in part on the indication of the subset of frequency bands supported for dynamic uplink transmission switching between the frequency bands.

In some aspects, the UE may transmit a first set of the one or more uplink communications via a first set of the one or more frequency bands. The UE may transmit the first set of the one or more uplink communications during a first time period. The UE may transmit a second set of the one or more uplink communications via a second set of the one or more frequency bands. The UE may transmit the second set of the one or more uplink communications during a second time period. In some aspects, the UE is configured to cease using the first set of the one or more frequency bands during the second time period to avoid violating configurations and/or capabilities of the UE. In some aspects, the UE may refrain from transmitting, during the second time period, via the first set of the one or more frequency bands. For example, the UE may consider an allocation to transmit using the first set of the one or more frequency bands during the second period as an error case and/or may ignore the allocation. Additionally, or alternatively, the base station may refrain from scheduling uplink communications via the first set of the one or more frequency bands during the second time period.

In some aspects, the UE may be configured and/or scheduled with a transmission gap (e.g., associated with an uplink transmission switching period) to cease using the first set of the one or more frequency bands and to begin used the second set of the one or more frequency bands.

Based at least in part on the UE transmitting an indication of supported frequency bands for dynamic uplink transmission switching (e.g., as a subset of frequency bands for uplink transmission switching), the UE may conserve computing, power, network, and/or communication resources that may have otherwise been used to attempt to use dynamic uplink transmission switching over with all of the frequency bands supported for uplink transmission switching. Additionally, or alternatively, the UE may conserve computing, power, network, and/or communication resources that may have otherwise been used to communication with unnecessary overhead and/or to detect and correct errors associated with attempting to use dynamic uplink transmission switching over with all of the frequency bands supported for uplink transmission switching (e.g., when an associated complexity exceeds a capability of the UE).

As indicated above, FIG. 5 is provided as an example. Other examples may differ from what is described with respect to FIG. 5.

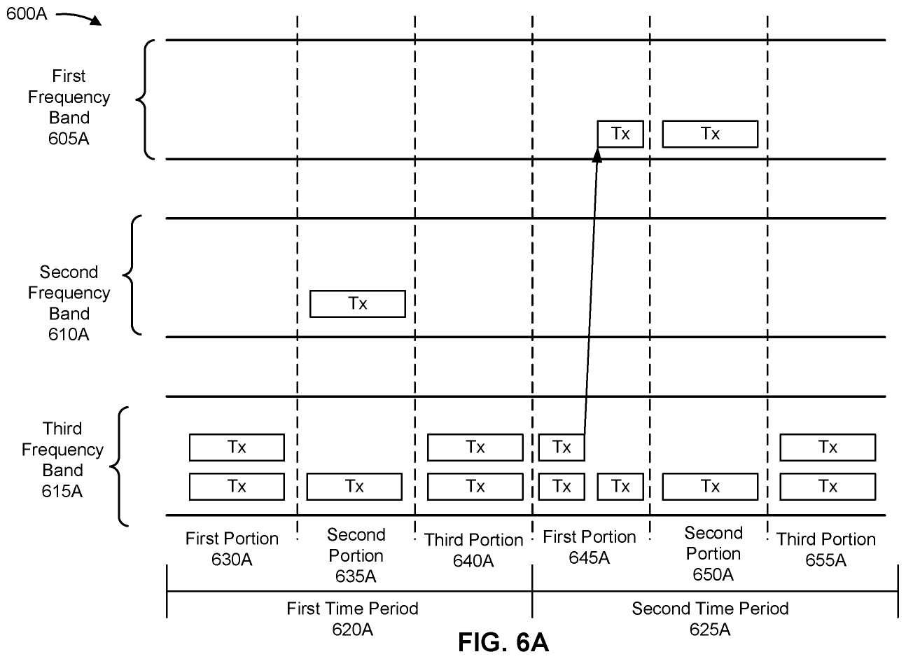

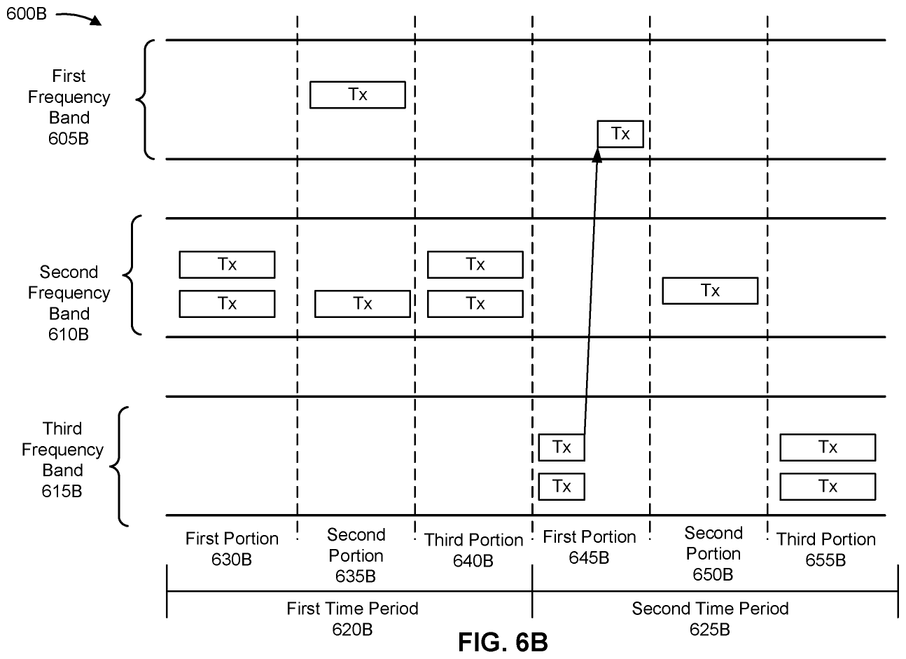

FIGS. 6A and 6B are diagrams illustrating examples 600A and 600B associated with dynamic uplink transmission switching, in accordance with the present disclosure. FIGS. 6A and 6B show dynamic uplink transmission switching that may occur in context of communications between a network node (e.g., base station 110, a CU, a DU, and/or an RU) and a UE (e.g., UE 120), among other examples (e.g., sidelink communications). In some aspects, the network node and the UE may be part of a wireless network (e.g., wireless network 100). The UE and the network node may have established a wireless connection prior to operations shown in FIGS. 6A and 6B.

As shown in FIG. 6A, the base station and the UE may be configured with a first frequency band 605A, a second frequency band 610A, and a third frequency band 615A. For example, the UE may have indicated support for uplink transmission switching between the first frequency band 605A, the second frequency band 610A, and the third frequency band 615A. In some aspects, the UE may indicate support for only 2 frequency bands (of the frequency bands 605A, 610A, and 615A) for dynamic uplink transmission switching. The UE may be configured to transmit uplink communications during a first time period 620A and during a second time period 625A.

During the first time period 620A, the base station may indicate (e.g., via an RRC configuration and/or MAC signaling, among other examples) that the UE is to use dynamic uplink transmission switching between the second frequency band 610A and the third frequency band 615A. The network node may indicate (e.g., via dynamic signaling, such as MAC CE or DCI, or via another scheduling communication, such as a configured grant using RRC, among other examples) that the UE is to transmit with two component carriers (e.g., using two transmission chains) of the second frequency band 615A during a first portion 630A of the first time period 620A, with one component carrier of the third frequency band 615A and one component carrier of the second frequency band 610A during a second portion 635A of the first time period 620A, and with two component carriers of the third frequency band 615A during a third portion 640A of the first time period 620A.

During the second time period 625A, the base station may indicate that the UE is to use dynamic uplink transmission switching between the first frequency band 605A and the third frequency band 615A. The network node may indicate that the UE is to transmit with two component carriers of the third frequency band 615A during part of a first portion 645A of the second time period 625A and with one component carrier of the third frequency band 615A and one component carrier of the first frequency band 605A during a second part of the first portion 645A, with one component carrier of the third frequency band 615A and one component carrier of the first frequency band 605A during a second portion 650A of the second time period 625A, and with two component carriers of the third frequency band 615A during a third portion 655A of the second time period 625A.

In some aspects, the network node may guarantee that the dynamic uplink transmission switching does not violate configurations of the UE and/or network across a configuration boundary (e.g., when switching from the first time period 620A to the second time period 625A).

As shown in FIG. 6B, the base station and the UE may be configured with a first frequency band 605B, a second frequency band 610B, and a third frequency band 615B. For example, the UE may have indicated support for uplink transmission switching between the first frequency band 605B, the second frequency band 610B, and the third frequency band 615B. In some aspects, the UE may indicate support for only 2 frequency bands (of the frequency bands 605B, 610B, and 615B) for dynamic uplink transmission switching. The UE may be configured to transmit uplink communications during a first time period 620B and during a second time period 625B.

During the first time period 620B, the base station may indicate (e.g., via an RRC configuration and/or MAC signaling, among other examples) that the UE is to use dynamic uplink transmission switching between the first frequency band 605B and the second frequency band 610B. The network node may indicate (e.g., via dynamic signaling, such as MAC CE or DCI, or via another scheduling communication, such as a configured grant using RRC, among other examples) that the UE is to transmit with two component carriers (e.g., using two transmission chains) of the second frequency band 615B during a first portion 630B of the first time period 620B, with one component carrier of the first frequency band 605B and one component carrier of the second frequency band 610B during a second portion 635B of the first time period 620B, and with two component carriers of the second frequency band 610B during a third portion 640B of the first time period 620B.

During the second time period 625B, the base station may indicate that the UE is to transmit with two component carriers of the third frequency band 615B during part of a first portion 645B of the second time period 625B. Based at least in part on the UE being configured for dynamic uplink transmission switching using the first frequency band 605B and the second frequency band 610B, and not being configured for dynamic uplink transmission switching using the third frequency band 615, an allocation and/or scheduling of transmission via the third frequency band 615 may indicate (e.g., implicitly) to switch off the first frequency band 605B and the second frequency band 610B. For example, the UE may disable dynamic uplink transmission switching, refrain from transmission via the first frequency band 605B and the 610B (e.g., ignoring any allocation or scheduling to use either of the frequency bands 605B or 610B), and/or disable simultaneous transmission via multiple frequency bands, among other examples, based at least in part on receiving the allocation and/or scheduling of transmission via the third frequency band 615B.

In some aspects, the network node may indicate that the UE is to transmit with one component carrier of the first frequency band 605B during a second part of the first portion 645B, with one component carrier of the second frequency band 610B during a second portion 650B of the second time period 625B, and with two component carriers of the third frequency band 615B during a third portion 655B of the second time period 625B.

In some aspects, the network node may guarantee that the dynamic uplink transmission switching does not violate configurations of the UE and/or network across a configuration boundary (e.g., when switching from the first time period 620A to the second time period 625A).

As indicated above, FIGS. 6A and 6B is provided as an example. Other examples may differ from what is described with respect to FIGS. 6A and 6B.

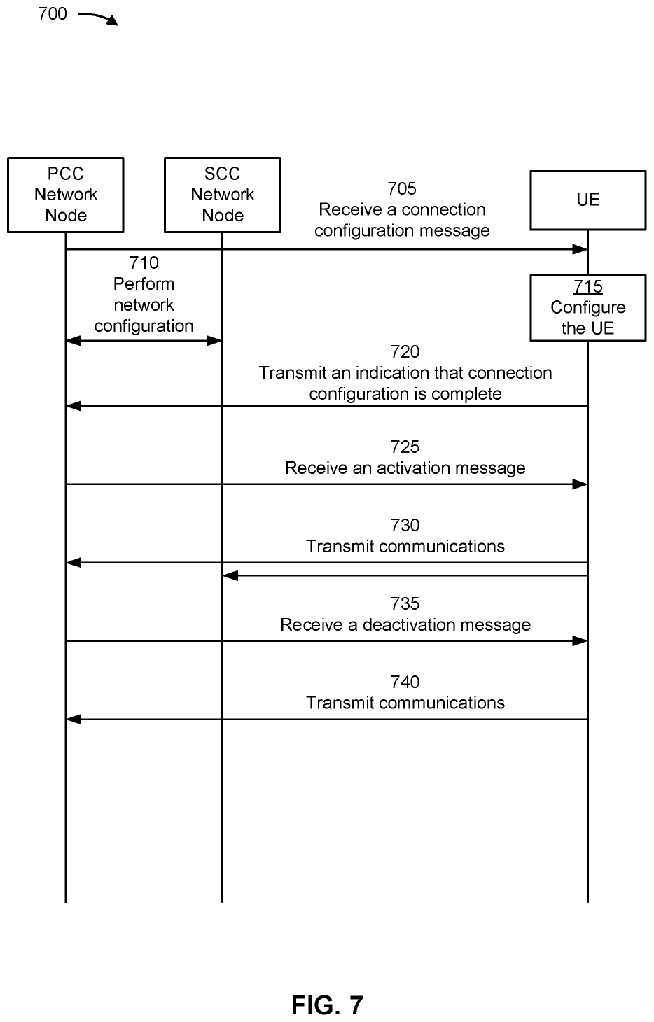

FIG. 7 is a diagram of an example 700 associated with dynamic uplink transmission switching, in accordance with the present disclosure. As shown in FIG. 7, network nodes (e.g., base station 110, a CU, a DU, and/or an RU) may communicate with a UE (e.g., UE 120). For example, the network nodes may include a primary component carrier (PCC) network node and a secondary component carrier (SCC) network node. In some aspects, the PCC network node and the SCC network node may be co-located, may be a same network node, and/or may share one or more components (e.g., a CU, a DU, and/or an RU). In some aspects, the network nodes and the UE may be part of a wireless network (e.g., wireless network 100). The UE and the PCC network node may have established a wireless connection prior to operations shown in FIG. 7.

As shown by reference number 705, the UE may receive, and the PCC network node may transmit, a connection configuration message. In some aspects, the connection configuration message may include an RRC message, such as an RRC connection reconfiguration message. The connection configuration message may indicate a configuration for the UE to use for dynamic uplink transmission switching and/or for communication with the PCC network node and the SCC network node during a time period.

As shown by reference number 710, the PCC network node and the SCC network node may perform network configuration. In some aspects, the PCC network node and the SCC network node may coordinate scheduling, frequency bands, and/or other resources to use for communication with the UE. The PCC network node and the SCC network node may perform network configuration based at least in part on receiving control messages from a network controller and/or a core network node, among other examples.

As shown by reference number 715, the UE may configure itself. For example, the UE may configure itself using the connection configuration message. The UE may be configured to communication using dynamic uplink transmission switching and/or a supplemental uplink configuration for communicating with the PCC network node and the SCC network node (e.g., simultaneously and/or during a same time period with communications overlapping and/or interwoven in time). The UE may configure one or more transmission chains of the UE for communication using dynamic uplink transmission switching and/or supplemental uplink communications.

As shown by reference number 720, the UE may transmit, and the PCC network node may receive, an indication that connection configuration is complete. For example, the UE may transmit an indication that RRC connection reconfiguration is complete.

As shown by reference number 725, the UE may receive, and the PCC network node may transmit, an activation message. The activation message may indicate that the UE is to begin using the configuration indicated in the connection configuration message described in connection with reference number 705. In some aspects, the activation message may include a MAC CE activation message or an RRC activation message.

As shown by reference number 730, the UE may transmit communications to the PCC network node and the SCC network node. The UE may transmit the communications based at least in part on the configuration indicated in the connection configuration message described in connection with reference number 705 and activated in the activation message described in connection with reference number 725.

As shown by reference number 735, the UE may receive, and the PCC network node may transmit, a deactivation message. The deactivation message may indicate that the UE is to cease using the configuration indicated in the connection configuration message described in connection with reference number 705. In some aspects, the deactivation message may include a MAC CE deactivation message or an RRC deactivation message.

As shown by reference number 730, the UE may transmit communications to the PCC network node and not to the SCC network node. The UE may transmit the communications based at least in part on the deactivation message described in connection with reference number 735.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with techniques for dynamic uplink transmission switching.

As shown in FIG. 8, in some aspects, process 800 may include transmitting an indication of a set of frequency bands supported for uplink transmission switching between frequency bands, the frequency bands including one or more bandwidth parts (block 810). For example, the UE (e.g., using communication manager 140 and/or transmission component 1004, depicted in FIG. 10) may transmit an indication of a set of frequency bands supported for uplink transmission switching between frequency bands, the frequency bands including one or more bandwidth parts, as described above.

As further shown in FIG. 8, in some aspects, process 800 may include transmitting an indication of a subset of the set of frequency bands, the subset supported for dynamic uplink transmission switching between the frequency bands (block 820). For example, the UE (e.g., using communication manager 140 and/or transmission component 1004, depicted in FIG. 10) may transmit an indication of a subset of the set of frequency bands, the subset supported for dynamic uplink transmission switching between the frequency bands, as described above.

As further shown in FIG. 8, in some aspects, process 800 may include transmitting one or more uplink communications via one or more frequency bands of the subset of the set of frequency bands (block 830). For example, the UE (e.g., using communication manager 140 and/or transmission component 1004, depicted in FIG. 10) may transmit one or more uplink communications via one or more frequency bands of the subset of the set of frequency bands, as described above.

Process 800 may include additional aspects, such as any single aspect or any combination of aspects described below and/or in connection with one or more other processes described elsewhere herein.

In a first aspect, process 800 includes transmitting an indication of support for transmitting the indication of the subset of the set of frequency bands.

In a second aspect, alone or in combination with the first aspect, process 800 includes receiving an indication of a set of candidate frequency bands that include the subset of the set of frequency bands.

In a third aspect, alone or in combination with one or more of the first and second aspects, the indication of the set of frequency bands indicates more than two frequency bands supported for uplink transmission switching.

In a fourth aspect, alone or in combination with one or more of the first through third aspects, the indication of the subset of the set of frequency bands indicates a number of frequency bands supported for dynamic uplink transmission switching, wherein the number of frequency bands supported for dynamic uplink transmission switching is less than or equal to a number of frequency bands within the set of frequency bands for uplink transmission switching.

In a fifth aspect, alone or in combination with one or more of the first through fourth aspects, the indication of the set of frequency bands comprises an indication of one or more switching periods associated with dynamic uplink transmission switching between frequency bands of the set of frequency bands.

In a sixth aspect, alone or in combination with one or more of the first through fifth aspects, process 800 includes receiving an indication to transmit the indication of the subset of the set of frequency bands, wherein transmission of the indication of the subset of the set of frequency bands is based at least in part on reception of the indication to transmit the indication.

In a seventh aspect, alone or in combination with one or more of the first through sixth aspects, the UE supports the subset of the set of frequency bands for dynamic uplink transmission switching for one or more of carrier aggregation or supplemental uplink.

In an eighth aspect, alone or in combination with one or more of the first through seventh aspects, process 800 includes receiving, based at least in part on the indication of the subset of the set of frequency bands, an indication of a configuration for transmitting the one or more uplink communications.

In a ninth aspect, alone or in combination with one or more of the first through eighth aspects, the configuration for transmitting the one or more uplink communications indicates a set of frequency bands configured for dynamic uplink transmission switching and a frequency band that is not configured for dynamic uplink transmission switching, wherein reception of an allocation for an uplink communication via the frequency band that is not configured for dynamic uplink transmission switching is associated with not receiving an allocation for an uplink communication via the set of frequency bands configured for dynamic uplink transmission switching.

In a tenth aspect, alone or in combination with one or more of the first through ninth aspects, the indication of the configuration for transmitting one or more uplink communications comprises an indication of multiple candidate frequency bands for dynamic uplink transmission switching, or an indication of a single frequency band supporting multiple carriers for dynamic uplink transmission switching.

In an eleventh aspect, alone or in combination with one or more of the first through tenth aspects, reception of the indication of the configuration for transmitting one or more uplink communications comprises receiving the indication via one or more of RRC signaling, medium access control signaling, or DCI.

In a twelfth aspect, alone or in combination with one or more of the first through eleventh aspects, the medium access control signaling or the DCI, after a configuration of the subset of the set of frequency bands via the RRC signaling, activates or deactivates one or more of the subset of the set of frequency bands, or one or more uplink carriers associated with the subset of the set of frequency bands.

In a thirteenth aspect, alone or in combination with one or more of the first through twelfth aspects, transmission of the one or more uplink communications via the one or more frequency bands of the subset of the set of frequency bands comprises transmitting, during a first time period, a first set of the one or more uplink communications via a first set of the one or more frequency bands, and transmitting, during a second time period, a second set of the one or more uplink communications via a second set of the one or more frequency bands, wherein the UE is configured to cease using the first set of the one or more frequency bands during the second time period.

In a fourteenth aspect, alone or in combination with one or more of the first through thirteenth aspects, transmission of the second time period, comprises refraining from transmitting, during the second time period, via the first set of the one or more frequency bands.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., base station 110) performs operations associated with techniques for dynamic uplink transmission switching.

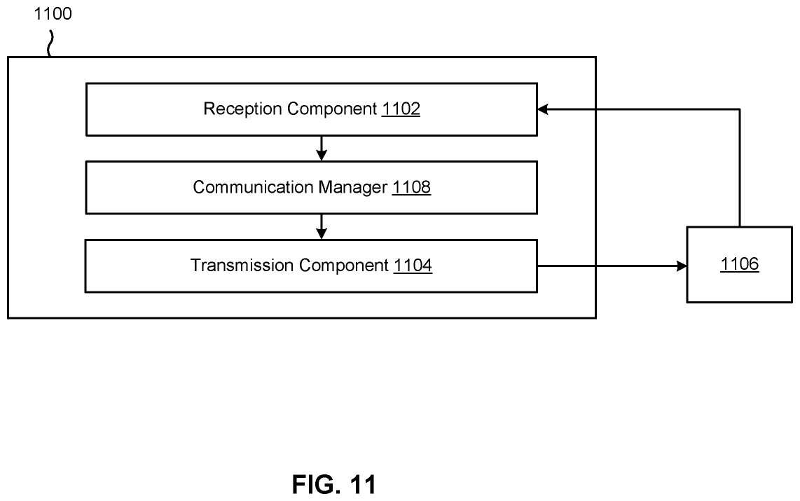

As shown in FIG. 9, in some aspects, process 900 may include receiving an indication of a set of frequency bands supported for uplink transmission switching between frequency bands, the frequency bands including one or more bandwidth parts (block 910). For example, the network node (e.g., using communication manager 150 and/or reception component 1102, depicted in FIG. 11) may receive an indication of a set of frequency bands supported for uplink transmission switching between frequency bands, the frequency bands including one or more bandwidth parts, as described above.

As further shown in FIG. 9, in some aspects, process 900 may include receiving an indication of a subset of the set of frequency bands, the subset supported for dynamic uplink transmission switching between the frequency bands (block 920). For example, the network node (e.g., using communication manager 150 and/or reception component 1102, depicted in FIG. 11) may receive an indication of a subset of the set of frequency bands, the subset supported for dynamic uplink transmission switching between the frequency bands, as described above.

As further shown in FIG. 9, in some aspects, process 900 may include receiving one or more uplink communications via one or more frequency bands of the subset of the set of frequency bands (block 930). For example, the network node (e.g., using communication manager 150 and/or reception component 1102, depicted in FIG. 11) may receive one or more uplink communications via one or more frequency bands of the subset of the set of frequency bands, as described above.

Process 900 may include additional aspects, such as any single aspect or any combination of aspects described below and/or in connection with one or more other processes described elsewhere herein.

In a first aspect, process 900 includes receiving an indication of support for transmitting the indication of the subset of the set of frequency bands.

In a second aspect, alone or in combination with the first aspect, process 900 includes transmitting an indication of a set of candidate frequency bands that include the subset of the set of frequency bands.

In a third aspect, alone or in combination with one or more of the first and second aspects, the indication of the set of frequency bands indicates more than two frequency bands supported for uplink transmission switching.

In a fourth aspect, alone or in combination with one or more of the first through third aspects, the indication of the subset of the set of frequency bands indicates a number of frequency bands supported for dynamic uplink transmission switching, wherein the number of frequency bands supported for dynamic uplink transmission switching is less than or equal to a number of frequency bands within the set of frequency bands for uplink transmission switching.

In a fifth aspect, alone or in combination with one or more of the first through fourth aspects, the indication of the set of frequency bands comprises an indication of one or more switching periods associated with dynamic uplink transmission switching between frequency bands of the set of frequency bands.

In a sixth aspect, alone or in combination with one or more of the first through fifth aspects, process 900 includes transmitting, to a UE, an indication to transmit the indication of the subset of the set of frequency bands, wherein transmission of the indication of the subset of the set of frequency bands is based at least in part on reception of the indication to transmit the indication.

In a seventh aspect, alone or in combination with one or more of the first through sixth aspects, the subset of the set of frequency bands for dynamic uplink transmission switching are associated with one or more of carrier aggregation or supplemental uplink.

In an eighth aspect, alone or in combination with one or more of the first through seventh aspects, process 900 includes transmitting, based at least in part on the indication of the subset of the set of frequency bands, an indication of a configuration for transmitting the one or more uplink communications.

In a ninth aspect, alone or in combination with one or more of the first through eighth aspects, the configuration for transmitting the one or more uplink communications indicates a set of frequency bands configured for dynamic uplink transmission switching and a frequency band that is not configured for dynamic uplink transmission switching, wherein reception of an allocation for an uplink communication via the frequency band that is not configured for dynamic uplink transmission switching is associated with not receiving an allocation for an uplink communication via the set of frequency bands configured for dynamic uplink transmission switching.

In a tenth aspect, alone or in combination with one or more of the first through ninth aspects, the indication of the configuration for transmitting one or more uplink communications an indication of multiple candidate frequency bands for dynamic uplink transmission switching, or an indication of a single frequency band supporting multiple carriers for dynamic uplink transmission switching.

In an eleventh aspect, alone or in combination with one or more of the first through tenth aspects, transmission of the indication of the configuration for transmitting one or more uplink communications comprises receiving the indication via one or more of RRC signaling, medium access control signaling, or DCI.

In a twelfth aspect, alone or in combination with one or more of the first through eleventh aspects, the medium access control signaling or the DCI, after a configuration of the subset of the set of frequency bands via the RRC signaling, activates or deactivates one or more of the subset of the set of frequency bands, or one or more uplink carriers associated with the subset of the set of frequency bands.

In a thirteenth aspect, alone or in combination with one or more of the first through twelfth aspects, reception of the one or more uplink communications via the one or more frequency bands of the subset of the set of frequency bands comprises receiving, during a first time period, a first set of the one or more uplink communications via a first set of the one or more frequency bands, and receiving, during a second time period, a second set of the one or more uplink communications via a second set of the one or more frequency bands, wherein a transmitting node is configured to cease using the first set of the one or more frequency bands during the second time period.

In a fourteenth aspect, alone or in combination with one or more of the first through thirteenth aspects, process 900 includes refraining from scheduling uplink communications via the first set of the one or more frequency bands during the second time period.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manger 1108 (e.g., the communication manager 140).

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The transmission component 1004 may transmit an indication of a set of frequency bands supported for uplink transmission switching between frequency bands, the frequency bands including one or more bandwidth parts. The transmission component 1004 may transmit an indication of a subset of the set of frequency bands, the subset supported for dynamic uplink transmission switching between the frequency bands. The transmission component 1004 may transmit one or more uplink communications via one or more frequency bands of the subset of the set of frequency bands.

The transmission component 1004 may transmit an indication of support for transmitting the indication of the subset of the set of frequency bands.

The reception component 1002 may receive an indication of a set of candidate frequency bands that include the subset of the set of frequency bands.

The reception component 1002 may receive an indication to transmit the indication of the subset of the set of frequency bands wherein transmission of the indication of the subset of the set of frequency bands is based at least in part on reception of the indication to transmit the indication.

The reception component 1002 may receive, based at least in part on the indication of the subset of the set of frequency bands, an indication of a configuration for transmitting the one or more uplink communications.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manage 1108 (e.g., the communication manager 150.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The reception component 1102 may receive an indication of a set of frequency bands supported for uplink transmission switching between frequency bands, the frequency bands including one or more bandwidth parts. The reception component 1102 may receive an indication of a subset of the set of frequency bands, the subset supported for dynamic uplink transmission switching between the frequency bands. The reception component 1102 may receive one or more uplink communications via one or more frequency bands of the subset of the set of frequency bands.

The reception component 1102 may receive an indication of support for transmitting the indication of the subset of the set of frequency bands.

The transmission component 1104 may transmit an indication of a set of candidate frequency bands that include the subset of the set of frequency bands.

The transmission component 1104 may transmit, to a UE, an indication to transmit the indication of the subset of the set of frequency bands wherein transmission of the indication of the subset of the set of frequency bands is based at least in part on reception of the indication to transmit the indication.

The transmission component 1104 may transmit, based at least in part on the indication of the subset of the set of frequency bands, an indication of a configuration for transmitting the one or more uplink communications.

The communication manager 1108 may refrain from scheduling uplink communications via the first set of the one or more frequency bands during the second time period.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: transmitting an indication of a set of frequency bands supported for uplink transmission switching between frequency bands, the frequency bands including one or more bandwidth parts; transmitting an indication of a subset of the set of frequency bands, the subset supported for dynamic uplink transmission switching between the frequency bands; and transmitting one or more uplink communications via one or more frequency bands of the subset of the set of frequency bands.

Aspect 2: The method of Aspect 1, further comprising: transmitting an indication of support for transmitting the indication of the subset of the set of frequency bands.

Aspect 3: The method of any of Aspects 1-2, further comprising: receiving an indication of a set of candidate frequency bands that include the subset of the set of frequency bands.

Aspect 4: The method of any of Aspects 1-3, wherein the indication of the set of frequency bands indicates more than two frequency bands supported for uplink transmission switching.

Aspect 5: The method of any of Aspects 1-4, wherein the indication of the subset of the set of frequency bands indicates a number of frequency bands supported for dynamic uplink transmission switching, wherein the number of frequency bands supported for dynamic uplink transmission switching is less than or equal to a number of frequency bands within the set of frequency bands for uplink transmission switching.

Aspect 6: The method of any of Aspects 1-5, wherein the indication of the set of frequency bands comprises: an indication of one or more switching periods associated with dynamic uplink transmission switching between frequency bands of the set of frequency bands.

Aspect 7: The method of any of Aspects 1-6, further comprising: receiving an indication to transmit the indication of the subset of the set of frequency bands, wherein transmission of the indication of the subset of the set of frequency bands is based at least in part on reception of the indication to transmit the indication.

Aspect 8: The method of any of Aspects 1-7, wherein the UE supports the subset of the set of frequency bands for dynamic uplink transmission switching for one or more of carrier aggregation or supplemental uplink.

Aspect 9: The method of any of Aspects 1-8, further comprising: receiving, based at least in part on the indication of the subset of the set of frequency bands, an indication of a configuration for transmitting the one or more uplink communications.

Aspect 10: The method of Aspect 9, wherein the configuration for transmitting the one or more uplink communications indicates a set of frequency bands configured for dynamic uplink transmission switching and a frequency band that is not configured for dynamic uplink transmission switching, wherein reception of an allocation for an uplink communication via the frequency band that is not configured for dynamic uplink transmission switching is associated with not receiving an allocation for an uplink communication via the set of frequency bands configured for dynamic uplink transmission switching.

Aspect 11: The method of any of Aspects 9-10, wherein the indication of the configuration for transmitting one or more uplink communications comprises: an indication of multiple candidate frequency bands for dynamic uplink transmission switching, or an indication of a single frequency band supporting multiple carriers for dynamic uplink transmission switching.

Aspect 12: The method of Aspect 11, wherein reception of the indication of the configuration for transmitting one or more uplink communications comprises receiving the indication via one or more of: radio resource control (RRC) signaling, medium access control signaling, or downlink control information (DCI).

Aspect 13: The method of Aspect 12, wherein the medium access control signaling or the DCI, after a configuration of the subset of the set of frequency bands via the RRC signaling, activates or deactivates one or more of: the subset of the set of frequency bands, or one or more uplink carriers associated with the subset of the set of frequency bands.

Aspect 14: The method of any of Aspects 1-13, wherein transmission of the one or more uplink communications via the one or more frequency bands of the subset of the set of frequency bands comprises: transmitting, during a first time period, a first set of the one or more uplink communications via a first set of the one or more frequency bands; and transmitting, during a second time period, a second set of the one or more uplink communications via a second set of the one or more frequency bands, wherein the UE is configured to cease using the first set of the one or more frequency bands during the second time period.

Aspect 15: The method of Aspect 14, wherein transmission of the second time period, comprises: refraining from transmitting, during the second time period, via the first set of the one or more frequency bands.

Aspect 16: A method of wireless communication performed by a network node, comprising: receiving an indication of a set of frequency bands supported for uplink transmission switching between frequency bands, the frequency bands including one or more bandwidth parts; receiving an indication of a subset of the set of frequency bands, the subset supported for dynamic uplink transmission switching between the frequency bands; and receiving one or more uplink communications via one or more frequency bands of the subset of the set of frequency bands.

Aspect 17: The method of Aspect 16, further comprising: receiving an indication of support for transmitting the indication of the subset of the set of frequency bands.

Aspect 18: The method of any of Aspects 16-17, further comprising: transmitting an indication of a set of candidate frequency bands that include the subset of the set of frequency bands.

Aspect 19: The method of any of Aspects 16-18, wherein the indication of the set of frequency bands indicates more than two frequency bands supported for uplink transmission switching.

Aspect 20: The method of any of Aspects 16-19, wherein the indication of the subset of the set of frequency bands indicates a number of frequency bands supported for dynamic uplink transmission switching, wherein the number of frequency bands supported for dynamic uplink transmission switching is less than or equal to a number of frequency bands within the set of frequency bands for uplink transmission switching.

Aspect 21: The method of any of Aspects 16-20, wherein the indication of the set of frequency bands comprises: an indication of one or more switching periods associated with dynamic uplink transmission switching between frequency bands of the set of frequency bands.

Aspect 22: The method of any of Aspects 16-21, further comprising: transmitting, to a user equipment (UE), an indication to transmit the indication of the subset of the set of frequency bands, wherein transmission of the indication of the subset of the set of frequency bands is based at least in part on reception of the indication to transmit the indication.

Aspect 23: The method of any of Aspects 16-22, wherein the subset of the set of frequency bands for dynamic uplink transmission switching are associated with one or more of carrier aggregation or supplemental uplink.

Aspect 24: The method of any of Aspects 16-23, further comprising: transmitting, based at least in part on the indication of the subset of the set of frequency bands, an indication of a configuration for transmitting the one or more uplink communications.

Aspect 25: The method of Aspect 24, wherein the configuration for transmitting the one or more uplink communications indicates a set of frequency bands configured for dynamic uplink transmission switching and a frequency band that is not configured for dynamic uplink transmission switching, wherein reception of an allocation for an uplink communication via the frequency band that is not configured for dynamic uplink transmission switching is associated with not receiving an allocation for an uplink communication via the set of frequency bands configured for dynamic uplink transmission switching.

Aspect 26: The method of any of Aspects 24-25, wherein the indication of the configuration for transmitting one or more uplink communications: an indication of multiple candidate frequency bands for dynamic uplink transmission switching, or an indication of a single frequency band supporting multiple carriers for dynamic uplink transmission switching.

Aspect 27: The method of Aspect 26, wherein transmission of the indication of the configuration for transmitting one or more uplink communications comprises receiving the indication via one or more of: radio resource control (RRC) signaling, medium access control signaling, or downlink control information (DCI).

Aspect 28: The method of Aspect 27, wherein the medium access control signaling or the DCI, after a configuration of the subset of the set of frequency bands via the RRC signaling, activates or deactivates one or more of: the subset of the set of frequency bands, or one or more uplink carriers associated with the subset of the set of frequency bands.

Aspect 29: The method of any of Aspects 16-28, wherein reception of the one or more uplink communications via the one or more frequency bands of the subset of the set of frequency bands comprises: receiving, during a first time period, a first set of the one or more uplink communications via a first set of the one or more frequency bands; and receiving, during a second time period, a second set of the one or more uplink communications via a second set of the one or more frequency bands, wherein a transmitting node is configured to cease using the first set of the one or more frequency bands during the second time period.

Aspect 30: The method of Aspect 29, further comprising: refraining from scheduling uplink communications via the first set of the one or more frequency bands during the second time period.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b +b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
transmitting an indication of a set of frequency bands supported for uplink transmission switching between frequency bands, the frequency bands including one or more bandwidth parts;
transmitting an indication of a subset of the set of frequency bands, the subset supported for dynamic uplink transmission switching between the frequency bands; and
transmitting one or more uplink communications via one or more frequency bands of the subset of the set of frequency bands.

2. The method of claim 1, further comprising:
transmitting an indication of support for transmitting the indication of the subset of the set of frequency bands.

3. The method of claim 1, further comprising:
receiving an indication of a set of candidate frequency bands that include the subset of the set of frequency bands.

4. The method of claim 1, wherein the indication of the set of frequency bands indicates more than two frequency bands supported for uplink transmission switching.

5. The method of claim 1, wherein the indication of the subset of the set of frequency bands indicates a number of frequency bands supported for dynamic uplink transmission switching,
wherein the number of frequency bands supported for dynamic uplink transmission switching is less than or equal to a number of frequency bands within the set of frequency bands for uplink transmission switching.

6. The method of claim 1, wherein the indication of the set of frequency bands comprises:
an indication of one or more switching periods associated with dynamic uplink transmission switching between frequency bands of the set of frequency bands.

7. The method of claim 1, further comprising:
receiving an indication to transmit the indication of the subset of the set of frequency bands,
wherein transmission of the indication of the subset of the set of frequency bands is based at least in part on reception of the indication to transmit the indication.

8. The method of claim 1, wherein the UE supports the subset of the set of frequency bands for dynamic uplink transmission switching for one or more of carrier aggregation or supplemental uplink.

9. The method of claim 1, further comprising:
receiving, based at least in part on the indication of the subset of the set of frequency bands, an indication of a configuration for transmitting the one or more uplink communications.

10. The method of claim 9, wherein the configuration for transmitting the one or more uplink communications indicates a set of frequency bands configured for dynamic uplink transmission switching and a frequency band that is not configured for dynamic uplink transmission switching,
wherein reception of an allocation for an uplink communication via the frequency band that is not configured for dynamic uplink transmission switching is associated with not receiving an allocation for an uplink communication via the set of frequency bands configured for dynamic uplink transmission switching.

11. The method of claim 9, wherein the indication of the configuration for transmitting one or more uplink communications comprises:
an indication of multiple candidate frequency bands for dynamic uplink transmission switching, or
an indication of a single frequency band supporting multiple carriers for dynamic uplink transmission switching.

12. The method of claim 11, wherein reception of the indication of the configuration for transmitting one or more uplink communications comprises receiving the indication via one or more of:
radio resource control (RRC) signaling,
medium access control signaling, or
downlink control information (DCI).

13. The method of claim 12, wherein the medium access control signaling or the DCI, after a configuration of the subset of the set of frequency bands via the RRC signaling, activates or deactivates one or more of:
the subset of the set of frequency bands, or
one or more uplink carriers associated with the subset of the set of frequency bands.

14. The method of claim 1, wherein transmission of the one or more uplink communications via the one or more frequency bands of the subset of the set of frequency bands comprises:
transmitting, during a first time period, a first set of the one or more uplink communications via a first set of the one or more frequency bands; and
transmitting, during a second time period, a second set of the one or more uplink communications via a second set of the one or more frequency bands,
wherein the UE is configured to cease using the first set of the one or more frequency bands during the second time period.

15. The method of claim 14, wherein transmission of the second time period, comprises:
refraining from transmitting, during the second time period, via the first set of the one or more frequency bands.

16. A method of wireless communication performed by a network node, comprising:
receiving an indication of a set of frequency bands supported for uplink transmission switching between frequency bands, the frequency bands including one or more bandwidth parts;
receiving an indication of a subset of the set of frequency bands, the subset supported for dynamic uplink transmission switching between the frequency bands; and
receiving one or more uplink communications via one or more frequency bands of the subset of the set of frequency bands.

17. The method of claim 16, further comprising:
receiving an indication of support for transmitting the indication of the subset of the set of frequency bands.

18. The method of claim 16, further comprising:
transmitting an indication of a set of candidate frequency bands that include the subset of the set of frequency bands.

19. The method of claim 16, wherein the indication of the set of frequency bands indicates more than two frequency bands supported for uplink transmission switching.

20. The method of claim 16, wherein the indication of the subset of the set of frequency bands indicates a number of frequency bands supported for dynamic uplink transmission switching,
wherein the number of frequency bands supported for dynamic uplink transmission switching is less than or equal to a number of frequency bands within the set of frequency bands for uplink transmission switching.

21. The method of claim 16, wherein the indication of the set of frequency bands comprises:
an indication of one or more switching periods associated with dynamic uplink transmission switching between frequency bands of the set of frequency bands.

22. The method of claim 16, further comprising:
transmitting, to a user equipment (UE), an indication to transmit the indication of the subset of the set of frequency bands,
wherein transmission of the indication of the subset of the set of frequency bands is based at least in part on reception of the indication to transmit the indication.

23. The method of claim 16, wherein the subset of the set of frequency bands for dynamic uplink transmission switching are associated with one or more of carrier aggregation or supplemental uplink.

24. The method of claim 16, further comprising:
transmitting, based at least in part on the indication of the subset of the set of frequency bands, an indication of a configuration for transmitting the one or more uplink communications.

25. The method of claim 24, wherein the configuration for transmitting the one or more uplink communications indicates a set of frequency bands configured for dynamic uplink transmission switching and a frequency band that is not configured for dynamic uplink transmission switching,
wherein reception of an allocation for an uplink communication via the frequency band that is not configured for dynamic uplink transmission switching is associated with not receiving an allocation for an uplink communication via the set of frequency bands configured for dynamic uplink transmission switching.

26. The method of claim 24, wherein the indication of the configuration for transmitting one or more uplink communications:
an indication of multiple candidate frequency bands for dynamic uplink transmission switching, or
an indication of a single frequency band supporting multiple carriers for dynamic uplink transmission switching.

27. The method of claim 26, wherein transmission of the indication of the configuration for transmitting one or more uplink communications comprises receiving the indication via one or more of:
radio resource control (RRC) signaling,
medium access control signaling, or
downlink control information (DCI).

28. The method of claim 27, wherein the medium access control signaling or the DCI, after a configuration of the subset of the set of frequency bands via the RRC signaling, activates or deactivates one or more of:
the subset of the set of frequency bands, or
one or more uplink carriers associated with the subset of the set of frequency bands.

29. The method of claim 16, wherein reception of the one or more uplink communications via the one or more frequency bands of the subset of the set of frequency bands comprises:
receiving, during a first time period, a first set of the one or more uplink communications via a first set of the one or more frequency bands; and
receiving, during a second time period, a second set of the one or more uplink communications via a second set of the one or more frequency bands, wherein a transmitting node is configured to cease using the first set of the one or more frequency bands during the second time period.

30. The method of claim 29, further comprising:
refraining from scheduling uplink communications via the first set of the one or more frequency bands during the second time period.

31. A user equipment (UE) for wireless communication, comprising:
a memory; and
one or more processors, coupled to the memory, configured to:
transmit an indication of a set of frequency bands supported for uplink transmission switching between frequency bands, the frequency bands including one or more bandwidth parts;
transmit an indication of a subset of the set of frequency bands, the subset supported for dynamic uplink transmission switching between the frequency bands; and
transmit one or more uplink communications via one or more frequency bands of the subset of the set of frequency bands.

32. A base station for wireless communication, comprising:
a memory; and
one or more processors, coupled to the memory, configured to:
receive an indication of a set of frequency bands supported for uplink transmission switching between frequency bands, the frequency bands including one or more frequency bandwidth parts;
receive an indication of a subset of the set of frequency bands, the subset supported for dynamic uplink transmission switching between the frequency bands; and
receive one or more uplink communications via one or more frequency bands of the subset of the set of frequency bands.

33.-36. (canceled)
